(19) United States
(12) Patent Application Publication
(10) Pub. No.: US 2025/0069355 A1
(43) Pub. Date: Feb. 27, 2025

(54) METHOD OF SETTING REGION OF INTEREST IN IMAGE FOR COLLECTING ROAD TRAFFIC INDEXES

(71) Applicant: NOTA, INC., Daejeon (KR)

(72) Inventors: Wondong Kim, Daejeon (KR); Seungyeon Choung, Daejeon (KR)

(21) Appl. No.: 18/809,217

(22) Filed: Aug. 19, 2024

(30) Foreign Application Priority Data
Aug. 21, 2023 (KR) 10-2023-0108756

(51) Int. Cl. G06V 10/25; G06T 7/20; G06V 20/54

(52) U.S. Cl. CPC G06V 10/25; G06T 7/20; G06V 20/54; G06T 2207/20104

(57) ABSTRACT

Provided is a method of setting a region of interest in an image for collecting road traffic indexes. The method according to an embodiment of the present invention includes displaying surveillance images collected in real time, setting a region of interest to obtain data related to movement of an object on the basis of an input of a user, outputting an indicator for obtaining additional data on the basis of the input of the user, outputting a selection user interface (UI) for selecting a region of interest related to the indicator, and linking the region of interest selected through the selection UI to the indicator.

### CROSS-REFERENCE TO RELATED APPLICATION

This application claims priority to and the benefit of Korean Patent Application No. 10-2013-0108756, filed on Aug. 21, 2023, the disclosure of which is incorporated herein by reference in its entirety.

### BACKGROUND

### 1. Field of the Invention

The present invention relates to collection of road traffic indexes, and more specifically, to a method of setting a region of interest in an image for collecting road traffic indexes, a device for performing the same, and a road traffic index collection system.

### 2. Discussion of Related Art

As vehicle usage increases, traffic congestion has emerged as a social problem, and technology for precisely collecting road traffic indexes to relieve traffic congestion is being focused on. Since the road traffic indexes are calculated from a region of interest of image data related to road traffic, it is important that the region of interest, which is an analysis target, is set correctly.

Conventionally, technology for setting a region of interest through a graphical user interface (GUI) was developed. In Korean Patent Registration No. 10-1652443, the content that an entire background screen is formed by arranging screens obtained through cameras and a main region of interest is set by specifying a monitoring region in the entire background screen through a GUI, and the content that a main monitoring region may be changed or canceled are disclosed. However, according to the related art, it is possible to simply set a region of interest, and reset a monitoring region according to a change in location of a camera, there are no indicators for detecting indexes such as a volume of traffic, a traveling direction, and/or an occupancy rate of objects in the region of interest when setting the region of interest, and thus there was a limitation in not being able to efficiently and precisely analyze indexes related to road traffic.

Therefore, there is a need for technology development and research on a method of setting a region of interest in an image for collecting road traffic indexes that is capable of increasing user convenience, a device for performing the same, and a road traffic index collection system.

### RELATED ART DOCUMENT

### Patent Document

1. Korean Patent Registration No. 10-1652443 (Registered on Aug. 24, 2016)

### SUMMARY OF THE INVENTION

The present invention is directed to providing a method of setting a region of interest in an image for collecting road traffic indexes that is capable of increasing precision of collection of road traffic indexes, a device for performing the same, and a road traffic index collection system.

The present invention is also directed to providing a method of setting a region of interest in an image for collecting road traffic indexes that is capable of increasing user convenience, a device for performing the same, and a road traffic index collection system.

Objects of the present invention are not limited to the above-described objects and other objects that are not described may be clearly understood by those skilled in the art from this specification and the accompanying drawings.

According to an aspect of the present invention, there is provided a method of setting a region of interest in an image for collecting road traffic indexes, which includes displaying surveillance images collected in real time, setting a region of interest to obtain data related to movement of an object on the basis of an input of a user, outputting an indicator for obtaining additional data on the basis of the input of the user, outputting a selection user interface (UI) for selecting a region of interest related to the indicator, and linking the region of interest selected through the selection UI to the indicator.

According to another aspect of the present invention, there is provided an electronic device which includes a communication module configured to receive image data captured by a camera, and a processor configured to set a region of interest for collecting road traffic indexes in the image data on the basis of the image data, wherein the processor is configured to display surveillance images collected in real time, set a region of interest to obtain data related to movement of an object on the basis of an input of a user, output an indicator for obtaining additional data on the basis of the input of the user, output a selection UI for selecting a region of interest related to the indicator, and link the region of interest selected through the selection UI to the indicator.

Solutions of the present invention are not limited to the above-described solutions and other solutions that are not described may be clearly understood by those skilled in the art from this specification and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating a road traffic index collection system according to an embodiment of the present invention;

FIG. 2 is a diagram for describing the operation of a road traffic index collection system according to an embodiment of the present invention;

FIG. 3 is a flowchart illustrating a method of setting a region of interest in an image for collecting road traffic indexes according to an embodiment of the present invention;

FIG. 4 is a diagram illustrating an aspect of regions of interest set in an image and indicators according to an embodiment of the present invention;

FIG. 5 is a diagram for describing an aspect of an information selection window for setting a region of interest according to an embodiment of the present invention;

FIG. 6 is a diagram for describing an aspect of an information selection window for setting a region of interest according to an embodiment of the present invention;

FIG. 7 is a diagram for describing an aspect of a user interface for linking a region of interest to an indicator according to an embodiment of the present invention;

FIG. 8 is a diagram for describing an aspect of a user interface for linking a region of interest to an indicator according to an embodiment of the present invention;

FIG. 9 is a diagram for describing an aspect of a user interface for linking a region of interest to an indicator according to an embodiment of the present invention;

FIG. 10 is a diagram for describing an aspect of a user interface for linking a region of interest to an indicator according to an embodiment of the present invention;

FIG. 11 is a diagram for describing an aspect of a user interface for linking a region of interest to an indicator according to an embodiment of the present invention;

FIG. 12 is a diagram for describing an aspect of object trajectory information displayed in an image according to an embodiment of the present invention; and

FIG. 13 is a diagram for describing an aspect of a time series chart related to a region of interest displayed in an image according to an embodiment of the present invention.

### DETAILED DESCRIPTION OF EXEMPLARY EMBODIMENTS

The above-described objects, features and, advantages of the present invention will be clearly understood through the following detailed description taken in conjunction with the accompanying drawings. However, while the present invention can be modified in various ways and take on various alternative forms, specific embodiments thereof are shown in the drawings and described in detail below as examples.

Like reference numerals refer to like elements in principle throughout the specification. Further, elements with the same function within the scope of the same idea shown in the drawings of each embodiment will be described using the same reference numerals, and the descriptions thereof will not be repeated.

When it is determined that detailed descriptions of related well-known functions or configurations may unnecessarily obscure the gist of the present invention, detailed descriptions thereof will be omitted. Further, the ordinal numbers (for example, first, second, etc.) used in description of the specification are used only to distinguish one element from another element.

Further, the term “module,” “unit,” “part,” or “portion” of an element used herein is assigned or incorporated for convenience of specification description, and the term itself does not have a distinct meaning or role.

As used herein, the singular forms “a” and “an” are intended to include the plural forms as well, unless the context clearly indicates otherwise.

It will be further understood that the terms “comprise,” “comprising,” “include,” and/or “including” used herein specify the presence of stated features or elements, but do not preclude the presence or addition of one or more other features or elements.

Sizes of elements in the drawings may be exaggerated for convenience of explanation. In other words, since sizes and thicknesses of elements in the drawings are arbitrarily illustrated for convenience of explanation, the following embodiments are not limited thereto.

When a certain embodiment may be implemented differently, a specific process order may be performed differently from the described order. For example, two consecutively described processes may be performed substantially at the same time or performed in an order opposite to the described order.

In the following embodiments, when a first element is referred to as being “connected” to a second element, it includes not only a case where the two elements are “directly connected,” but also a case where the two elements are “indirectly connected” with a third element interposed therebetween. For example, in this specification, when a first element is referred to as being “electrically connected” to a second element, it includes not only a case where the two elements are “directly electrically connected,” but also a case where the two elements are “indirectly electrically connected” with a third element interposed therebetween.

A method of setting a region of interest in an image for collecting road traffic indexes according to an embodiment of the present invention may include displaying surveillance images collected in real time, setting a region of interest to obtain data related to movement of an object on the basis of an input of a user, outputting an indicator for obtaining additional data on the basis of the input of the user, outputting a selection user interface (UI) for selecting a region of interest related to the indicator, and linking the region of interest selected through the selection UI to the indicator.

According to one embodiment of the present invention, the region of interest may include a vehicle region-of-interest for measuring movement of a vehicle and a pedestrian region-of-interest for measuring movement of a pedestrian.

According to one embodiment of the present invention, the indicator may include a vehicle indicator that is linkable to the vehicle region-of-interest and a pedestrian indicator that is linkable to the pedestrian region-of-interest.

According to one embodiment of the present invention, a UI may be displayed together with the surveillance images, the UI may include a region-of-interest icon for setting the region of interest, a vehicle indicator icon for setting the vehicle indicator, and a pedestrian indicator icon for setting the pedestrian indicator, when the user selects the vehicle indicator icon, the selection UI may display a preset vehicle region-of-interest, and when the user selects the pedestrian indicator icon, the selection UI may display a preset pedestrian region-of-interest.

According to one embodiment of the present invention, the vehicle indicator may include a loop detector for detecting an occupancy rate within the vehicle region-of-interest and a direction vector for measuring an exit direction of the vehicle, and when the direction vector is set as a first direction and a second direction, a number of vehicles exiting from the vehicle region-of-interest in the first direction and the second direction may be measured.

According to one embodiment of the present invention, the direction vector may be displayed as an arrow indicating the exit direction, and when the direction vector is linked to the vehicle region-of-interest, the link between the direction vector and the vehicle region-of-interest may be displayed through a linker.

According to one embodiment of the present invention, the pedestrian indicator may include a pedestrian measurer for counting an amount of traffic for pedestrians moving in the pedestrian region-of-interest, the UI may further include a vector icon, when a setting input of a straight line is received in the pedestrian region-of-interest after the vector icon is selected, the straight line may be set to the pedestrian measurer, and when a setting input of a straight line is received in a region adjacent to the vehicle region-of-interest after the vector icon is selected, the straight line may be set to the direction vector.

According to one embodiment of the present invention, the region of interest may further include a speed measurement region for measuring a moving speed of a vehicle in a specific region in the surveillance image, and when the region of interest and the indicator overlap, the indicator is displayed preferentially.

According to one embodiment of the present invention, the method may further include after the region-of-interest icon is selected, displaying an information selection window, wherein information that is selectable through the information selection window is determined according to a type of the region of interest.

According to one embodiment of the present invention, the selectable information may be determined based on pre-learned data.

According to one embodiment of the present invention, the method may further include displaying a heat map on the surveillance image based on the input of the user, wherein the heat map may be generated by analyzing the surveillance images for an accumulated time.

According to one embodiment of the present invention, the UI may be displayed together with the surveillance images, and the UI may include an accumulated time input region for inputting the accumulated time.

According to one embodiment of the present invention, the method may further include when a selection for the set region of interest is received, displaying a time series chart related to the object measured in the region of interest.

According to one embodiment of the present invention, information on the object displayed through the heat map may be different from information on the object displayed through the time series chart.

According to one embodiment of the present invention, a computer-readable recording medium on which a program for performing the method of setting the region of interest in the image is recorded may be provided.

An electronic device according to an embodiment of the present invention may include a communication module configured to receive image data captured by a camera, and a processor configured to set a region of interest for collecting road traffic indexes in the image data on the basis of the image data, wherein the processor may be configured to display surveillance images collected in real time, set a region of interest to obtain data related to movement of an object on the basis of an input of a user, output an indicator for obtaining additional data on the basis of the input of the user, output a selection UI for selecting a region of interest related to the indicator, and link the region of interest selected through the selection UI to the indicator.

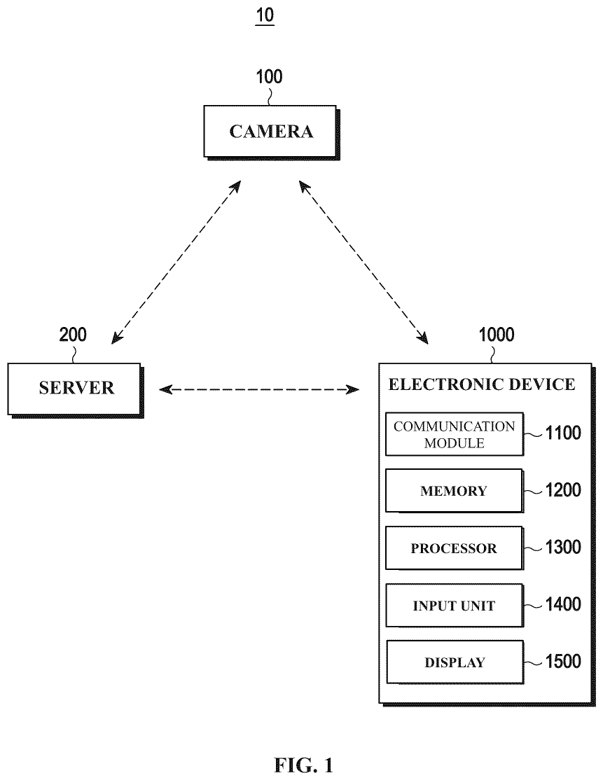

Hereinafter, a method of setting a region of interest in an image for collecting road traffic indexes, a device for performing the same, and a road traffic index collection system according to embodiments of the present invention will be described in more detail with reference to FIGS. 1 to 13.

FIG. 1 is a schematic diagram illustrating a road traffic index collection system 10 according to an embodiment of the present invention.

Referring to FIG. 1, the road traffic index collection system 10 may include a camera 100, a server 200, and/or an electronic device 1000.

The camera 100 may obtain image data related to road traffic. For example, the camera 100 may be a closed-circuit television (CCTV) that captures image data (or video data) related to road traffic related to an intersection. Furthermore, the camera 100 may transmit the image data to the server 200 and/or the electronic device 1000.

The server 200 may analyze image data captured through the camera 100. For example, the server 200 may analyze the image data and calculate object trajectory information in an image. For example, the server 200 may be configured to analyze the image data, calculate trajectories of objects (e.g., vehicle objects, pedestrian objects, two-wheeled vehicle objects, etc.) in the image, and store cumulative values of the calculated object trajectories. Furthermore, the server 200 may transmit the image data and/or results of the analysis of the image data (e.g., the object trajectory information) to an external device, including the electronic device 1000. Furthermore, the server 200 may be configured to receive and store set information on a region of interest for collecting road traffic indexes from the electronic device 1000. Furthermore, the server 200 may identify an object moving in the region of interest on the basis of the set information on the region of interest and perform an operation of calculating the road traffic indexes.

Meanwhile, in FIG. 1, the server 200 has been illustrated as being a single server. However, this is only an example for convenience of description, and the server 200 may include an edge device and a back-end server.

The electronic device 1000 may receive a real-time surveillance image through the server 200. For example, the electronic device 1000 may receive the real-time surveillance image captured by the camera 100 via the server 200. For example, when a video management system (VMS) is installed, the electronic device 1000 may receive the real-time surveillance image captured by the camera 100 from the VMS. For example, the electronic device 1000 may receive an image address, in which the surveillance image is stored, from the server 200 and receive the surveillance image from the corresponding image address of the VMS on the basis of the received image address. However, this is only an example, and the electronic device 1000 may be configured to directly receive a real-time surveillance image related to road traffic from the camera 100.

The electronic device 1000 may receive a user input for setting the region of interest in the image to collect the road traffic indexes. For example, the electronic device 1000 may be configured to provide a UI for setting the region of interest to the user, receive the user input through the UI for setting the region of interest, set the region of interest, and transmit information on the set region of interest (intersection setting information) to the external device, including the server 200. Meanwhile, the electronic device 1000 may be a personal computer (PC), a tablet computer, a smartphone, a smart watch, and/or a personal digital assistant (PDA).

The electronic device 1000 may include a communication module 1100, a memory 1200, a processor 1300, an input unit 1400, and/or a display 1500.

The communication module 1100 of the electronic device 1000 may communicate with any external device or an external server. For example, the electronic device 1000 may receive the image data, which is obtained through the camera 100, from the camera 100 and/or the server 200 through the communication module 1100. For example, the electronic device 1000 may receive the object trajectory information related to movement of the object in the image from the server 200 through the communication module 1100. For example, the electronic device 1000 may transmit the information on the region of interest set in the image to the server 200 according to the user input, through the communication module 1100. However, this is only an example, and the electronic device 1000 may transmit or receive any appropriate data and/or commands to or from any component included in the road traffic index collection system 10 through the communication module 1100.

The electronic device 1000 may access a network through the communication module 1100 to transmit or receive various types of data. The communication module 1100 may largely include a wired-type communication module 1100 and a wireless-type communication module 1100. Since the wired-type communication module 1100 and the wireless-type communication module 1100 have their own advantages and disadvantages, in some cases, the wired-type communication module 1100 and the wireless-type communication module 1100 may be provided together as the electronic device 1000. Here, in the case of the wireless-type communication module 1100, a wireless local area network (WLAN) type communication method such as Wi-Fi may be mainly used. Alternatively, in the case of the wireless-type communication module 1100, cellular communication, such as long-term evolution (LTE) or 5^{th}-generation (5G) communication method, may be used. However, a wireless communication protocol is not limited to the above-described example, and any appropriate wireless type of communication method may be used. In the case of the wired-type communication module 1100, a LAN or Universal Serial Bus (USB) communication is a representative example, but other methods may also be used.

Various types of information may be stored in the memory 1200 of the electronic device 1000. Various types of data may be temporarily or semi-permanently stored in the memory 1200. Examples of the memory 1200 may include a hard disk drive (HDD), a solid state drive (SSD), a flash memory, a read-only memory (ROM), a random access memory (RAM), etc. The memory 1200 may be provided as embedded in the electronic device 1000 or in a detachable form. Various types of data necessary for the operation of the electronic device 1000, including an operating program (OS) for driving the electronic device 1000 or a program for operating each component of the electronic device 1000, may be stored in the memory 1200.

The processor 1300 may control the overall operation of the electronic device 1000. For example, the processor 1300 may control the overall operation of the electronic device 1000, including an operation of displaying a surveillance image obtained by the camera 100, an operation of setting a region of interest, an operation of outputting an indicator, an operation of outputting a UI for selecting a region of interest related to the indicator, and/or an operation of linking the selected region of interest to the indicator and calculating intersection setting information, etc., which will be described below. Specifically, the processor 1300 may load and execute a program for the overall operation of the electronic device 1000 from the memory 1200. The processor 1300 may be implemented as an application processor (AP), a central processing unit (CPU), a microcontroller unit (MCU), or a similar device depending on hardware, software, or a combination thereof. In this case, the processor 1300 may be provided in the form of an electronic circuit that processes electrical signals and performs a control function in hardware, and may be provided in the form of a program or code that drives a hardware circuit in software.

The input unit 1400 is a component for inputting a user input or a user command. The electronic device 1000 may receive any appropriate user input or user command through the input unit 1400, including an input for selecting a specific region (e.g., an arbitrary UI element) in the image.

The input unit 1400 may include a key pad, a dome switch, a touch pad (e.g., a static pressure/capacitive touch pad), a jog wheel, a jog switch, and a sensor (e.g., a voice sensor, a proximity sensor, an illumination sensor, an acceleration sensor, a gyro sensor, etc.). The input unit 1400 may be implemented in the form of a button on the outside of the electronic device 1000, and some buttons may be implemented as a touch panel. When a user input (e.g., a text input, a voice input, a user device operation change, etc.) for rule definition and rule execution (e.g., command) is received, the input unit 1400 may generate input data according to the received user input.

The display 1500 may output information related to the road traffic index collection system 10. For example, the display 1500 may output surveillance images collected in real time. For example, the display 1500 may output a UI element for receiving a user input for setting a region of interest for collecting road traffic indexes. For example, the display 1500 may output an indicator for obtaining additional data. For example, the display 1500 may output a UI element for selecting a region of interest related to the indicator. For example, the display 1500 may output the object trajectory information. For example, the display 1500 may output the road traffic indexes. However, this is only an example, and the display 1500 may be configured to output any appropriate information related to the road traffic index collection system 10 in any appropriate form.

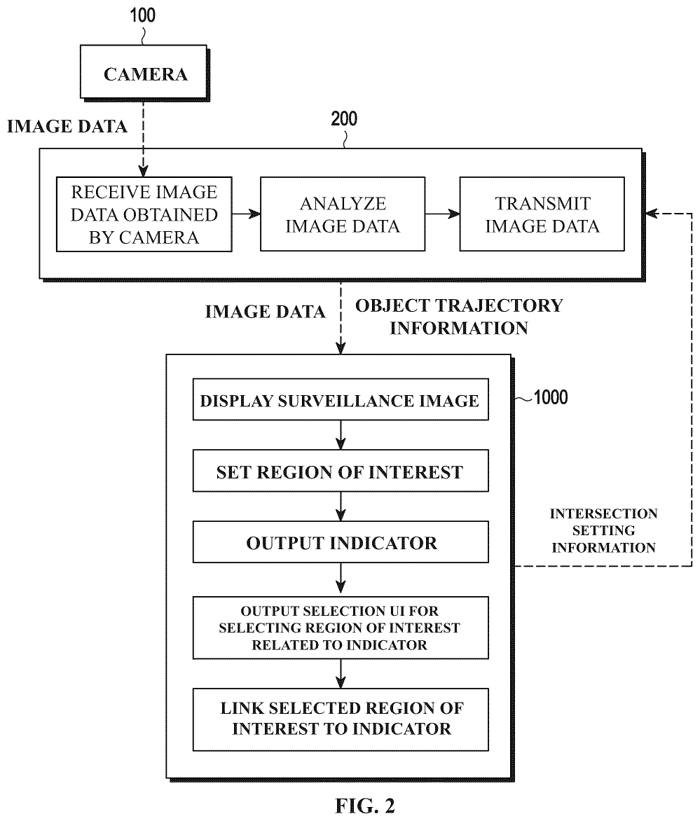

FIG. 2 is a diagram for describing the operation of a road traffic index collection system 10 according to an embodiment of the present invention.

The camera 100 may obtain image data related to road traffic. For example, the camera 100 may be a CCTV for monitoring traffic situations at an intersection. The camera 100 may transmit the image data to a VMS and/or the server 200 through the communication module.

The server 200 may receive the image data related to the road traffic from the camera 100 through the communication module. For example, the server 200 may receive the image data directly from the camera 100 or receive the image data through a VMS.

The server 200 may perform an operation of analyzing the image data.

For example, the server 200 may perform an operation of analyzing the image data and calculating object trajectory information. The object trajectory information may include pixel information of a region corresponding to at least one object (e.g., a vehicle object, a pedestrian object, a two-wheeled vehicle object, etc.) included in the image data, or direction information of the object. The object trajectory information may be in the form of heat map data.

For example, the server 200 may perform an operation of analyzing the image data on the basis of the set region of interest and/or the indicator and calculating road traffic indexes.

The server 200 may perform an operation of transmitting the image data through the communication module. Specifically, the server 200 may transmit the image data, the calculated object trajectory information, and/or history information related to the road traffic indexes to the electronic device 1000 through the communication module.

Meanwhile, in FIGS. 1 and 2, the server 200 according to the embodiment of the present invention has been illustrated as being a single component. However, this is only an example for convenience of description, and the server 200 may be implemented with a plurality of components. For example, the server 200 may include an edge device and a back-end server. In this case, the edge device may perform an operation of receiving image data obtained by the camera 100, analyzing the image data, and transmitting the image data. For example, the edge device may perform an operation of analyzing the image data and calculating object trajectory information related to an object in the image data. For example, when a region of interest is set through the electronic device 1000, the edge device may perform an operation of detecting an object corresponding to the set region of interest using the set region of interest. Furthermore, the back-end server may be implemented to perform data management and/or application programming interface (API) serving operations.

Meanwhile, in FIG. 2, it has been described that the server 200 analyzes the image data. However, this is only an example, and the electronic device 1000 may be implemented to perform an operation of analyzing the image data.

The electronic device 1000 according to the embodiment of the present invention may perform an operation of receiving a real-time surveillance image from the camera 100, the VMS, and/or the server 200 through the communication module 1100, displaying the received real-time surveillance image through the display 1500, and outputting the received real-time surveillance image to a user.

The electronic device 1000 according to the embodiment of the present invention may provide a UI for setting a region of interest to the user. In this case, the electronic device 1000 may perform an operation of receiving a user input of the UI for setting the region of interest through the input unit 1400, and setting the region of interest on the basis of the received user input. The region of interest may include a region of interest for measuring movement of a pedestrian or a two-wheeled vehicle, a region of interest for measuring movement of a vehicle, a region of interest for determining whether the vehicle is entering or exiting an intersection, and/or a region of interest for measuring a speed of the vehicle.

The electronic device 1000 according to the embodiment of the present invention may provide a UI for setting an indicator for obtaining additional data to the user. The indicator may include an indicator that is linkable to the region of interest for measuring the movement of the pedestrian or two-wheeled vehicle, and/or an indicator that is linkable to the region of interest for measuring the movement of the vehicle. The electronic device 1000 may perform an operation of receiving a user input of the UI for setting the indicator through the input unit 1400, and displaying and outputting the indicator on the surveillance image on the basis of the received user input.

The electronic device 1000 according to the embodiment of the present invention may output a selection UI for selecting the region of interest related to the indicator and provide the selection UI to the user. More specifically, the electronic device 1000 may be implemented to receive a user input specifying a region of interest to be linked to the indicator and link the selected region of interest to the indicator on the basis of the received user input.

The electronic device 1000 according to the embodiment of the present invention may be configured to transmit intersection setting information including at least one set region of interest, at least one set indicator, and/or information related to a link between the region of interest and the indicator to the server 200 through the communication module 1100.

Meanwhile, although not illustrated in FIG. 2, the electronic device 1000 may perform an operation of displaying a heat map related to the cumulative occupancy rate of the object in the real-time surveillance image on the basis of the object trajectory information received from the server 200. Furthermore, the electronic device 1000 may perform an operation of displaying a time series chart related to the road traffic indexes in the real-time surveillance image in response to the user input for selecting a specific region of interest, on the basis of the history information of the road traffic indexes that is received from the server 200.

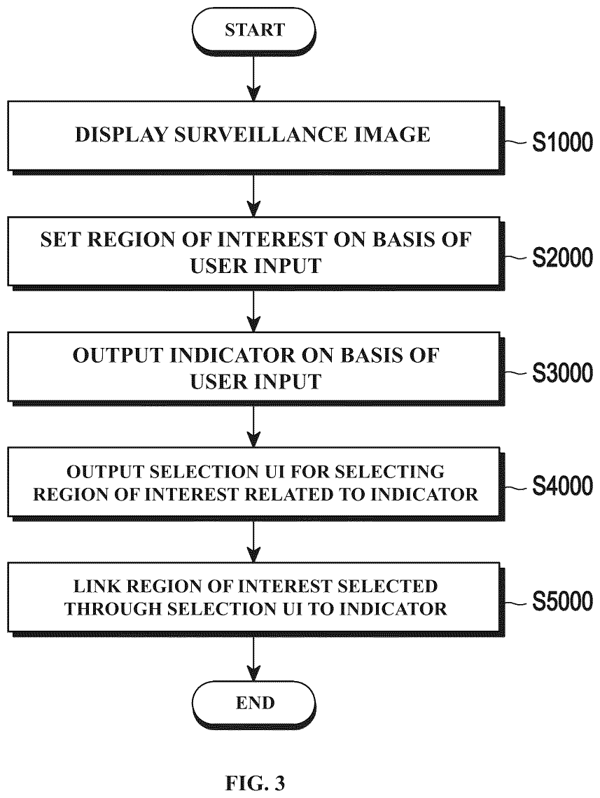

Hereinafter, a method of setting a region of interest in an image for collecting road traffic indexes according to an embodiment of the present invention will be described with reference to FIGS. 3 to 13. Meanwhile, in describing the method of setting the region of interest in the image for collecting the road traffic indexes, descriptions of some embodiments that overlap the content previously described with reference to FIGS. 1 and 2 may be omitted. However, this is only for convenience of description and should not be construed for purposes of limitation.

FIG. 3 is a flowchart illustrating a method of setting a region of interest in an image for collecting road traffic indexes according to an embodiment of the present invention.

The method of setting the region of interest in the image according to the embodiment of the present invention may include an operation S1000 of displaying a surveillance image, an operation S2000 of setting a region of interest on the basis of a user input, an operation S3000 of outputting an indicator on the basis of the user input, an operation S4000 of outputting a selection UI for selecting a region of interest related to the indicator, and/or an operation S5000 of linking the region of interest selected through the selection UI to the indicator.

In the operation S1000 of displaying the surveillance image, the electronic device 1000 may receive a surveillance image related to road traffic that is captured by the camera 100, through the communication module 1100. Specifically, the electronic device 1000 may receive the surveillance image related to the road traffic collected in real time through the camera 100, from the server 200 through the communication module 1100.

In the operation S1000 of displaying the surveillance image, the electronic device 1000 may output the received surveillance image through the display 1500.

In the operation S2000 of setting the region of interest on the basis of the user input, the electronic device 1000 may set at least one region of interest to obtain data related to movement of an object on the basis of the user input.

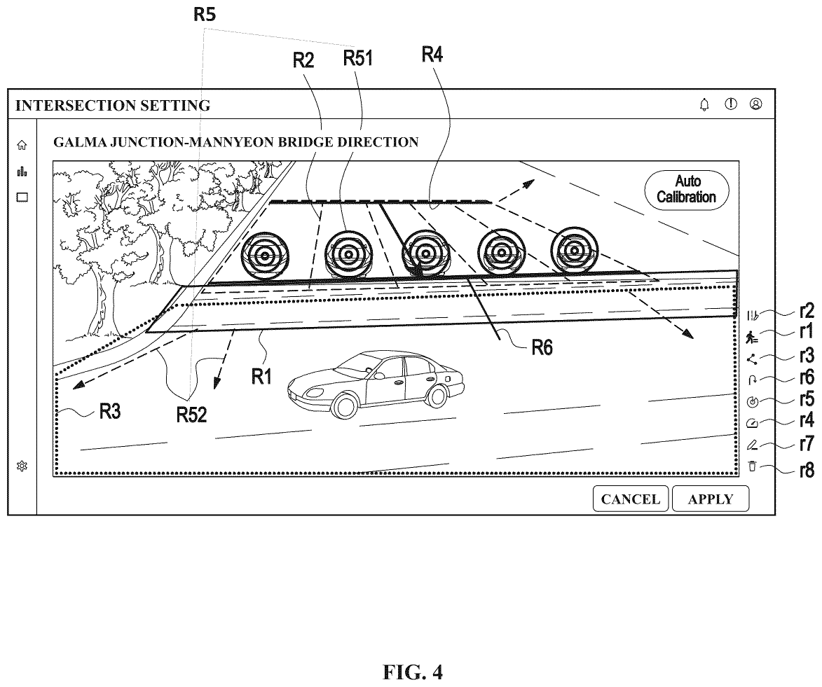

FIG. 4 is a diagram illustrating an aspect of regions of interest set in an image and indicators according to an embodiment of the present invention.

The regions of interest may include a first region-of-interest (R1 of FIG. 4 or which may be referred to as a pedestrian region-of-interest) for measuring movement of a pedestrian or two-wheeled vehicle, a second region-of-interest (R2 of FIG. 4 or which may be referred to as a vehicle region-of-interest) for measuring movement of a vehicle, a third region-of-interest (R3 of FIG. 4 or which may be referred to as an intersection region of interest) for detecting that the vehicle enters or exits an intersection, and/or a fourth region-of-interest (R4 of FIG. 4) for measuring a speed of the vehicle.

The first region-of-interest may be a region in the surveillance image, which is related to a crosswalk region in which pedestrians or two-wheeled vehicles pass. The server 200 may calculate road traffic indexes related to a volume of traffic of pedestrians or two-wheeled vehicles moving through the set first region-of-interest, on the basis of intersection setting information including the set first region-of-interest.

The second region-of-interest may be a region in the surveillance image, which is related to a lane region in which vehicles pass. The server 200 may calculate road traffic indexes related to a volume of traffic of vehicles moving through the set second region-of-interest and/or a queue length of vehicles waiting on the second region-of-interest, on the basis of the intersection setting information including the set second region-of-interest.

The third region-of-interest may be a region for determining whether a vehicle enters or exits and identifying an intersection, in the surveillance image. The server 200 may determine whether a direction in which the vehicle identified in the surveillance image is moving is a direction toward the set third region-of-interest to determine whether the vehicle enters or exits, on the basis of the intersection information including the set third region-of-interest.

The fourth region-of-interest may be a region for measuring a speed of a vehicle moving in a specific section, in the surveillance image. The fourth region-of-interest may be defined with a start line corresponding to a start point of a section for measuring the speed of the vehicle, an end line corresponding to an end point of the section, and/or an arrow indicating a direction of movement of the vehicle. The server 200 may calculate road traffic indexes related to the speed of the vehicle (e.g., an average speed within a section), on the basis of a time between a time point at which a vehicle object passes the start line and a time point at which the vehicle object passes the end line and a distance between the start line and the end line.

In the operation S2000 of setting the region of interest on the basis of the user input, the electronic device 1000 may provide a UI for setting the region of interest through the display 1500. In this case, the electronic device 1000 may obtain a user input requesting the setting of the region of interest through the input unit 1400, and set at least one region of interest to obtain data related to movement of the object on the basis of the user input.

The electronic device 1000 according to the embodiment of the present invention may display the UI for setting the region of interest together with the surveillance image.

The UI may include at least one region-of-interest icon for setting regions of interest.

For example, the UI may include a region-of-interest icon r1 for setting a first region-of-interest R1. When a user input for selecting the region-of-interest icon r1 is received through the input unit 1400, the electronic device 1000 may be implemented to display an information selection window for setting the first region-of-interest R1 for measuring movement of a pedestrian or two-wheeled vehicle or display a preset first region-of-interest R1 on the surveillance image.

For example, the UI may include a region-of-interest icon r2 for setting a second region-of-interest R2. When a user input for selecting the region-of-interest icon r2 is received through the input unit 1400, the electronic device 1000 may be implemented to display an information selection window for setting the second region-of-interest R2 for measuring movement of a vehicle or display a preset second region-of-interest R2 on the surveillance image.

For example, the UI may include a region-of-interest icon r3 for setting a third region-of-interest R3. When a user input for selecting the region-of-interest icon r3 is received through the input unit 1400, the electronic device 1000 may be implemented to provide a function for setting the third region-of-interest R3 for determining whether a vehicle enters or exits or display a preset third region-of-interest R3 on the surveillance image.

For example, the UI may include a region-of-interest icon r4 for setting a fourth region-of-interest R4. When a user input for selecting the region-of-interest icon r4 is received through the input unit 1400, the electronic device 1000 may be implemented to provide a function for setting the fourth region-of-interest R4 for measuring a speed of a vehicle or display a preset fourth region-of-interest R4 on the surveillance image.

Meanwhile, the UI may further include an edit icon r7 for editing a set region of interest and/or a delete icon r8 for deleting the set region of interest. When a user input for selecting the edit icon r7 is received through the input unit 1400, the electronic device 1000 may provide a function for editing the set region of interest and/or an indicator which will be described below. Alternatively, when a user input for selecting the delete icon r8 is received through the input unit 1400, the electronic device 1000 may provide a function for deleting the set region of interest and/or an indicator which will be described below.

The electronic device 1000 according to the embodiment of the present invention may provide the UI by activating a region-of-interest icon corresponding to a region of interest to be set and deactivating icons for other region regions of interest other than the region of interest to be set.

For example, when the user input for selecting the region-of-interest icon r1 for setting the first region-of-interest is received through the input unit 1400, the electronic device 1000 may be implemented to provide the UI by activating the region-of-interest icon r1 and deactivating region-of-interest icons (e.g., r2, r3, and r4) that are less relevant to the first region-of-interest.

Meanwhile, when the region of interest corresponding to the region-of-interest icon is set in the surveillance image following the user input for selecting the region-of-interest icon, the electronic device 1000 may be implemented to automatically provide an editing function for the set region of interest, and provide the UI by activating the edit icon r7 or deactivating the delete icon r8.

The operation S2000 of setting the region of interest on the basis of the user input according to the embodiment of the present invention may further include displaying an information selection window after the region-of-interest icon is selected, and adding information on the region of interest on the basis of the user input through the information selection window.

Specifically, when the user input for selecting the region-of-interest icon is received, the electronic device 1000 may output the information selection window for setting the information on the region of interest through the display 1500. The information selection window may include at least one piece of selectable information, and the selectable information may be determined according to the type of region of interest. Furthermore, the selectable information may be determined based on pre-learned data. Specifically, based on the dataset where the region-of-interest icons and/or regions-of-interest, and at least one selectable information corresponding to the selected region-of interest icons and/or regions-of-interest, are matched with each other, pre-training for artificial intelligence model (AI model) may be performed to output the matched selectable information with information selection window, when a specific region-of-interest icon and/or region-of-interest is selected. For example, when user input selecting a region-of-interest icon r1 and/or defining a first region-of-interest R1 is received, pre-training for AI model may be performed to output the matched selectable information (e.g. type of detection target (e.g., a pedestrian, a bicycle, an adult, a child) passing through the first region-of-interest R1) corresponding the region-of-interest icon r1 and/or region-of-interest R1 with information selection window.

Therefore, when the electronic device (1000) receives user input selecting a specific region-of-interest icon and/or region-of-interest, pre-trained AI model may determine the selectable information based on user input and output the determined selectable information to the information selection window.

Meanwhile, it was explained that the pre-training is performed through AI model. However, this is merely an example, and the pre-training can be performed using any suitable model and/or algorithm.

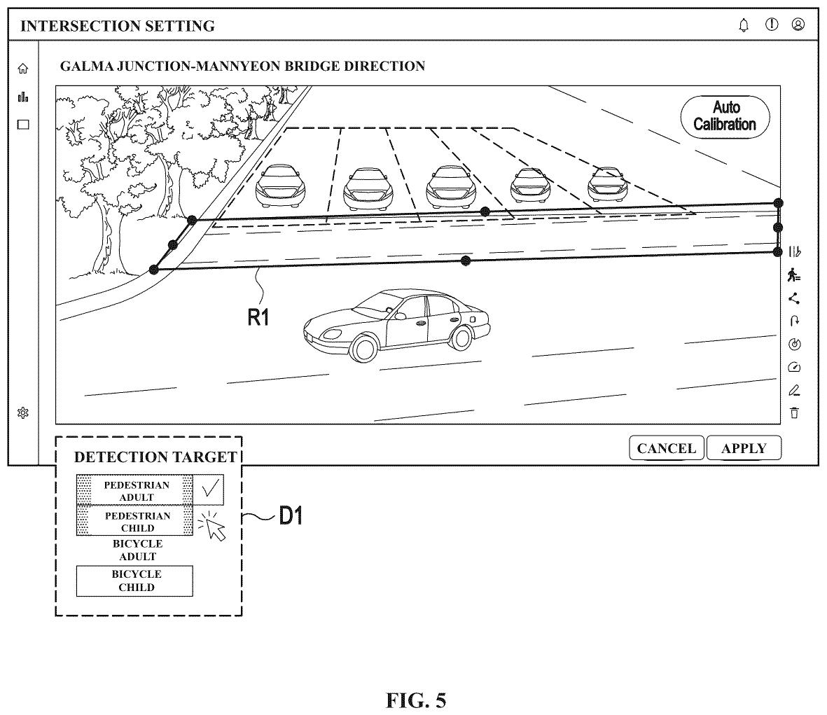

FIG. 5 is a diagram for describing an aspect of an information selection window for a setting region of interest according to an embodiment of the present invention.

For example, when a user input for selecting a region-of-interest icon r1 is received and a user input for defining a first region-of-interest R1 is received, the electronic device 1000 may output a first information selection window D1 for setting information on the first region-of-interest R1. For example, the first information selection window D1 may include at least one piece of selectable information related to a type of detection target (e.g., a pedestrian, a bicycle, an adult, a child) passing through the first region-of-interest R1. In this case, the selectable information included in the first information selection window D1 may be determined based on the type of first region-of-interest. Further, the selectable information included in the first information selection window D1 may be determined based on pre-learned data used to calculate road traffic indexes related to a volume of traffic of pedestrians or two-wheeled vehicles passing through the first region-of-interest. For example, in order to calculate the road traffic indexes related to the volume of traffic of the pedestrians or two-wheeled vehicles passing through the first region-of-interest, when trained with learning data for identifying an adult pedestrian, a child pedestrian, an adult on a bicycle, and a child on a bicycle passing through the first region-of-interest in the surveillance image, the selectable information included in the first information selection window D1 may be determined to be information on a pedestrian adult, a pedestrian child, a bicycle adult, and a bicycle child on the basis of the pre-learned data.

Meanwhile, when the electronic device 1000 receives the user's selection for the type of detection target (e.g., the pedestrian adult and the pedestrian children in FIG. 5) in relation to the first information selection window D1, the server 200 may be implemented to measure road traffic indexes (e.g., a volume of traffic of adult pedestrians or a volume of traffic of child pedestrians) corresponding to the type of selected detection target on the basis of the type of selected detection target.

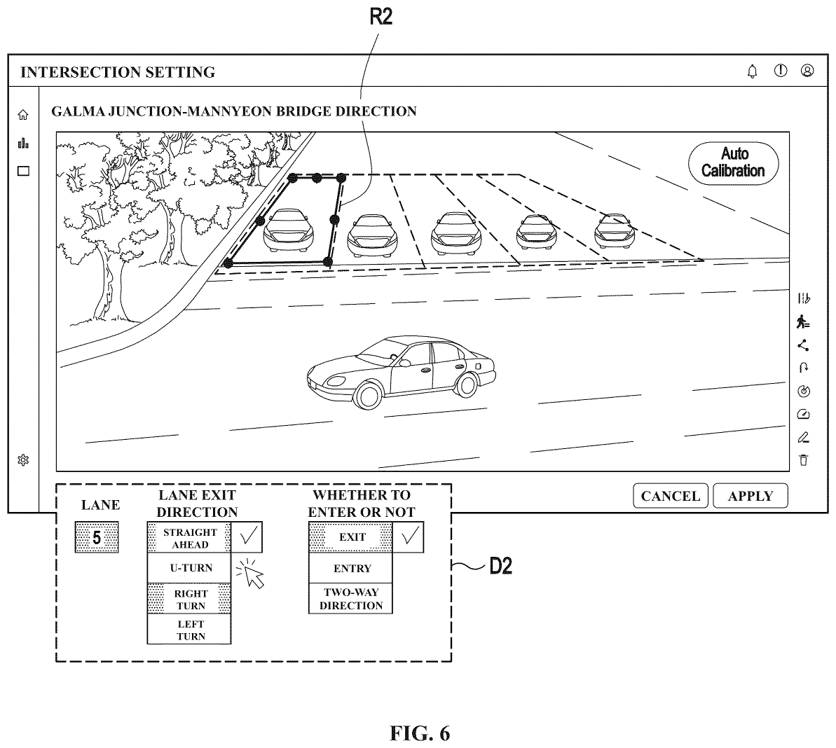

FIG. 6 is a diagram for describing an aspect of an information selection window for setting a region of interest according to an embodiment of the present invention.

For example, when a user input for selecting a region-of-interest icon r2 is received and a user input for defining a second region-of-interest R2 is received, the electronic device 1000 may output a second information selection window D2 for setting information on the second region-of-interest R2. For example, the second information selection window D2 may include selectable information related to a location of a road (or lane) corresponding to the set second region-of-interest R2 (e.g., first lane to n^{th} lane), a lane exit direction (e.g., straight ahead, U-turn, right turn, or left turn) of a vehicle passing through the set second region-of-interest R2, and/or whether the vehicle passing through the second region-of-interest R2 exits or enters the set second region-of-interest R2 (e.g., exit, entry, or two-way direction). In this case, the selectable information included in the second information selection window D2 may be determined based on the type of second region-of-interest. Further, the selectable information included in the second information selection window D2 may be determined based on pre-learned data used to calculate road traffic indexes related to a volume of traffic, a queue length, and/or an occupancy rate of vehicles passing through the second region-of-interest. For example, in order to calculate the road traffic indexes related to the volume of traffic, the queue length, and/or the occupancy rate of the vehicles passing through the second region-of-interest, when trained with learning data including information on the lane of the second region-of-interest in the surveillance image, the second information selection window D2 may include information on selectable lanes or information on inputtable lanes. For example, in order to calculate the road traffic indexes related to the volume of traffic, the queue length, and/or the occupancy rate of the vehicles passing through the second region-of-interest, when trained with learning data including information on a direction of entry into the lane of the second region-of-interest in the surveillance image, the selectable information included in the second information selection window D2 may be determined to be information on straight ahead, U-turn, right turn, or left turn on the basis of the pre-learned data. For example, in order to calculate the road traffic indexes related to the volume of traffic, the queue length, and/or the occupancy rate of the vehicles passing through the second region-of-interest, when trained with learning data including information on whether to enter or exit the second region-of-interest in the surveillance image, the selectable information included in the second information selection window D2 may be determined to be information on exit, entry, or two-way direction on the basis of the pre-learned data.

Meanwhile, when the electronic device 1000 receives the user's selection for the type of lane (e.g., fifth lane in FIG. 6), the type of lane exit direction (e.g., straight ahead direction or right turn direction in FIG. 6), and the type of exit/entry (e.g., exit in FIG. 6) in relation to the second information selection window D2, the server 200 may be implemented to measure road traffic indexes (e.g., a volume of traffic of vehicles entering the second region-of-interest of fifth lane in the straight ahead direction and/or right turn direction, a queue length on fifth lane, an occupancy rate of fifth lane) on the basis of the selected information.

Meanwhile, in FIGS. 5 and 6, it has been described that the information selection windows including the selectable information of specific examples are provided. However, this is only an example for convenience of description and should not be construed as limited. Therefore, the electronic device 1000 according to the embodiment of the present invention may be implemented to provide an information selection window of any appropriate type including any appropriate selectable information to the user.

In the operation S3000 of outputting the indicator on the basis of the user input, the electronic device 1000 may output an indicator for obtaining additional data on the basis of the user input.

Descriptions will be given with reference to FIG. 4 again.

The indicator may include a first indicator R6 (which may be referred to as a “pedestrian indicator”) that is linkable to the first region-of-interest R1 (or the pedestrian region-of-interest), and a second indicator R5 (which may be referred to as a “vehicle indicator”) that is linkable to the second region-of-interest R2 (or the vehicle region-of-interest).

The first indicator R6 may be an indicator for measuring a volume of traffic of pedestrians or two-wheeled vehicles passing through the first region-of-interest R1. For example, the first indicator R6 may be linked to the first region-of-interest R1 and may be displayed in the form of a straight line between a starting point of the first region-of-interest R1 and an ending point of the first region-of-interest R1. For example, the first indicator R6 may be displayed in the form of a straight line crossing a direction of traffic of the pedestrians or two-wheeled vehicles. In this case, the server 200 may identify pedestrian objects or two-wheeled vehicle objects passing through the first indicator R6 displayed in the form of the straight line, and calculate road traffic indexes related to the volume of traffic of the pedestrians or two-wheeled vehicles moving in the set first region-of-interest R1 by measuring the number of identified pedestrian objects or two-wheeled vehicle objects.

The second indicator R5 may be an indicator for detecting an occupancy rate within the second region-of-interest R2 or measuring an exit direction of a vehicle passing through the second region-of-interest R2. For example, the second indicator R5 may include a loop detector R51 for detecting the occupancy rate within the second region-of-interest R2. The server 200 may be implemented to calculate road traffic indexes related to a time occupancy rate of the vehicle within the second region-of-interest R2 on the basis of values measured through the loop detector R51. For example, the second indicator R5 may include at least one direction vector R52 for measuring the exit direction of the vehicle passing through the second region-of-interest R2. The server 200 may be implemented to measure the number of vehicles entering from the second region-of-interest R2 in the direction corresponding to the direction vector R52 on the basis of at least one direction vector R52, and calculate road traffic indexes related to the volume of traffic of the vehicles passing through the second region-of-interest R2 on the basis of the measured number of vehicles.

In the operation S3000 of outputting the indicator on the basis of the user input, the electronic device 1000 may provide a UI for setting the indicator through the display 1500. In this case, the electronic device 1000 may obtain a user input requesting the setting of the indicator through the input unit 1400, and display at least one indicator for obtaining data related to the movement of the object in the surveillance image through the display 1500, on the basis of the user input.

The electronic device 1000 according to the embodiment of the present invention may display a UI for setting the indicator together with the surveillance image.

The UI may include at least one indicator icon for setting the indicator.

For example, the UI may include a direction vector icon r6 for setting the direction vector R52 of the first indicator R6 or second indicator R5. When a user input for selecting the direction vector icon r6 is received through the input unit 1400, the electronic device 1000 may be implemented to display a selection UI window (will be described below) for linking the first indicator R6 to the preset first region-of-interest R1, or display the preset first region-of-interest R1 on the surveillance image. When the user input for selecting the direction vector icon r6 is received through the input unit 1400, the electronic device 1000 may be implemented to display a selection UI window (will be described below) for linking the direction vector R52 of the second indicator R5 and the preset second region-of-interest R2, or display at least one preset second region-of-interest R2 on the surveillance image.

For example, the UI may include a vehicle indicator icon r5 for setting the second indicator R5. When a user input for selecting the vehicle indicator icon r5 is received through the input unit 1400, the electronic device 1000 may be implemented to display a selection UI window (will be described below) for selecting a region to be linked to the second indicator R5 from among one or more second regions-of-interest R2, or display one or more second regions-of-interest R2 on the surveillance image.

In the operation S4000 of outputting the selection UI for selecting the region of interest related to the indicator, the electronic device 1000 may output the selection UI for selecting a region of interest to be connected to the indicator in response to the user input for setting the indicator in operation S3000.

According to one embodiment, the electronic device 1000 may output the selection UI for selecting a region of interest to be connected to at least one direction vector R52 in response to the user input for setting the direction vector R52 related to the second indicator R5 in operation S3000.

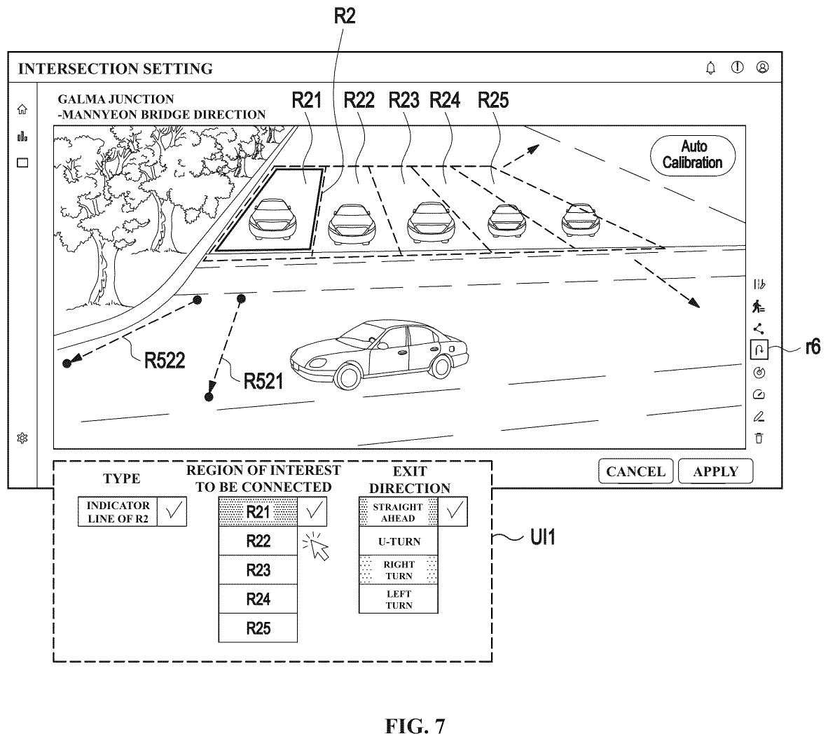

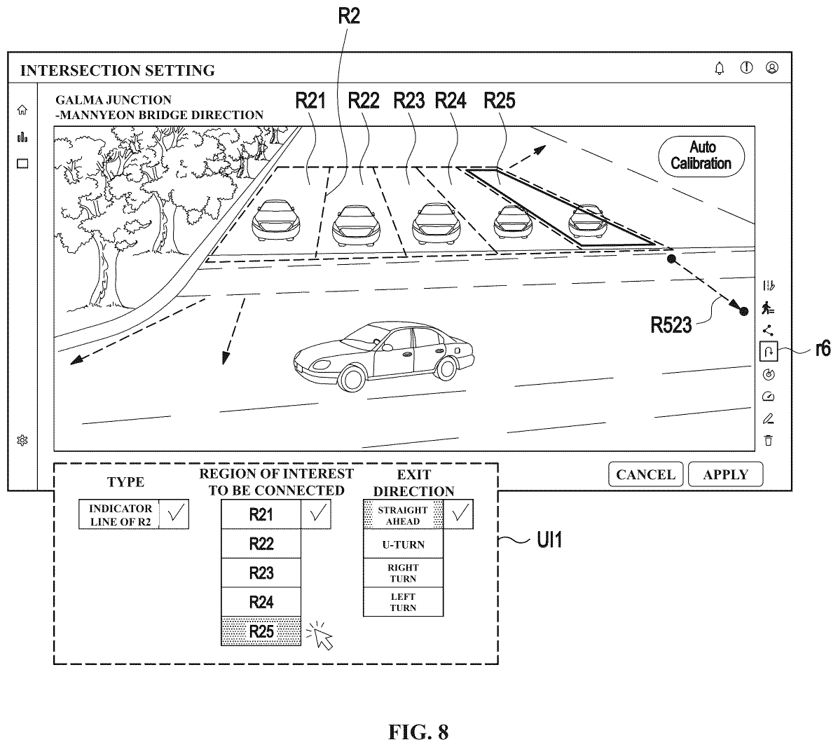

FIG. 7 is a diagram for describing an aspect of a UI for linking a region of interest to an indicator according to an embodiment of the present invention. FIG. 8 is a diagram for describing an aspect of a UI for linking a region of interest to an indicator according to an embodiment of the present invention.

When the electronic device 1000 receives a user input for selecting the indicator icon (e.g., the direction vector icon r6) for setting direction vectors R521 and R522 related to the second indicator R5, the electronic device 1000 may output, through the display 1500, a first selection UI element UI1 for selecting a region of interest to be connected to the direction vectors R521 and R522 in response to the user input. The first selection UI element UI1 may include a UI element for selecting information related to the type of direction vector, a region of interest to be connected to the direction vector, and/or an exit direction of the direction vector.

Referring to FIGS. 7 and 8, the electronic device 1000 may receive the information related to the type of direction vector, a region of interest to be connected to the direction vector, and/or the exit direction of the direction vector from the user through the first selection UI element UI1.

For example, the user may select, through the input unit 1400, an indicator line of R2 as the type of direction vectors R521 and R522 related to the second indicator R5. Furthermore, the user may select, through the input unit 1400, one region (e.g., R21) from among a plurality of second regions-of-interest R21 to R25 as the region of interest to be connected to the direction vectors R521 and R522 related to the second indicator R5. Furthermore, the user may select, through the input unit 1400, the exit direction (e.g., straight ahead or turn right) of the direction vectors R521 and R522 related to the second indicator R5.

For example, the user may select the indicator line of R2 as the type of direction vector R523 related to the second indicator R5. Furthermore, the user may select a region (e.g., R25) from among the plurality of second regions-of-interest R21 to R25 as the region of interest to be connected to the direction vector R523 related to the second indicator R5. Furthermore, the user may select the exit direction (e.g., straight ahead) of the direction vector R523 related to the second indicator R5.

Meanwhile, in FIGS. 7 and 8, it has been mainly described that the first selection UI for connecting the specific regions-of-interest R21 and R25 and the direction vector is provided. However, this is only an example for convenience of description, and the electronic device 1000 may be implemented to connect the direction vector to an arbitrary region of interest through the first selection UI.

Meanwhile, in FIGS. 7 and 8, it has been described that the exit direction of the direction vector related to the second indicator R5 is directly selected by the user. However, this is only an example, and the electronic device 1000 may be implemented to automatically set the exit direction of the direction vector related to the second indicator R5 on the basis of the user's selection for the lane exit direction in the information selection window D2 for the second region-of-interest (see FIG. 6), and the user's selection for the region of interest to be connected for the first selection UI (see FIGS. 7 and 8).

Furthermore, in FIGS. 7 and 8, it has been described that the region of interest to be connected to the direction vector related to the second indicator R5 is directly selected by the user. However, this is only an example, and the electronic device 1000 may be implemented to determine the second region-of-interest to be connected to the direction vector R52 related to the second indicator R5 on the basis of the location where a setting input is received after the indicator icon (e.g., the direction vector icon r6) is selected. Specifically, when the electronic device 1000 receives a straight line setting input in a region adjacent to the second region-of-interest R2 after the indicator icon (e.g., the direction vector icon r6) is selected, the electronic device 1000 may determine the type of direction vector R52 related to the second indicator R5 as the indicator line of R2, and determine the region of interest to be connected to the direction vector R52 related to the second indicator R5 as the second region-of-interest R2 adjacent to the location where the straight line setting input is received.

Meanwhile, the straight line that is input according to the straight line setting input may be set as a direction vector indicating the exit direction of the vehicle passing through the second region-of-interest R2. Furthermore, the set direction vector may be displayed on the image as an arrow indicating the exit direction.

According to one embodiment, the electronic device 1000 may output the selection UI for selecting the region of interest to be connected to the loop detector R51 in response to the user input for setting the loop detector R51 of the second indicator R5 in operation S3000.

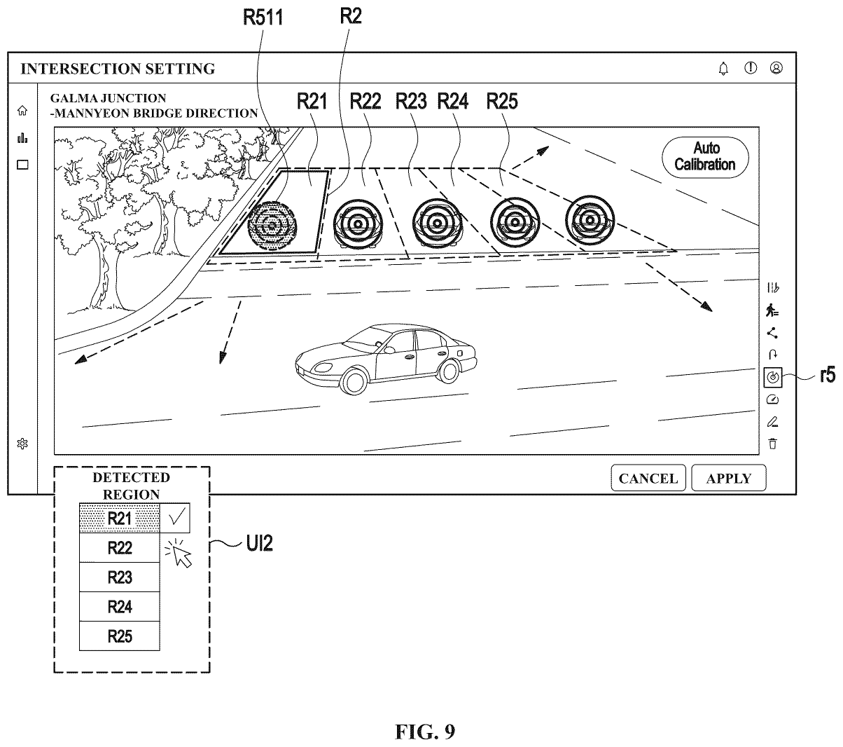

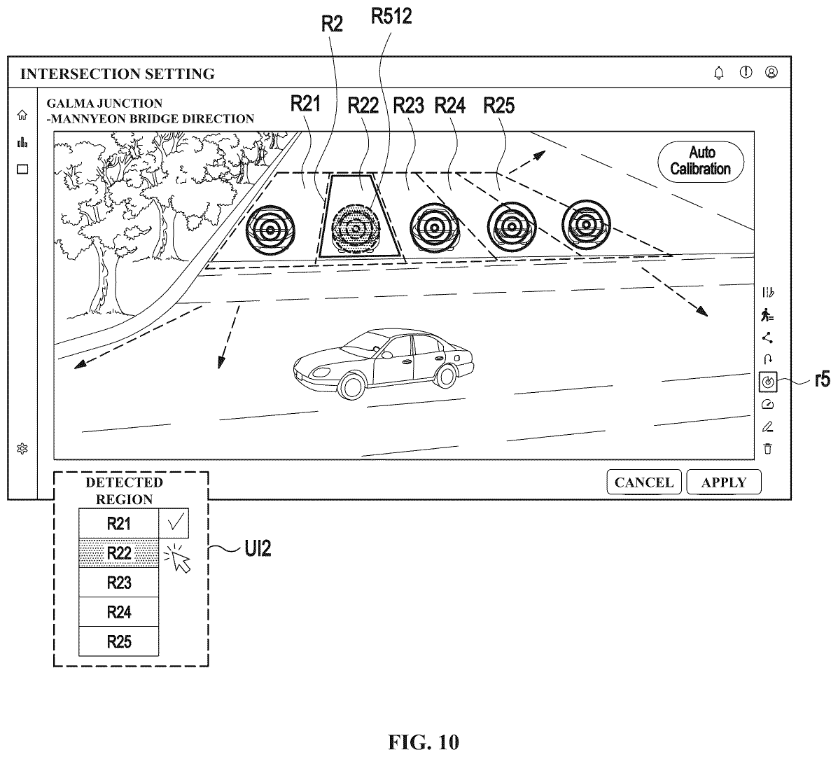

FIG. 9 is a diagram for describing an aspect of a UI for linking a region of interest to an indicator according to an embodiment of the present invention. FIG. 10 is a diagram for describing an aspect of a UI for linking a region of interest to an indicator according to an embodiment of the present invention.

When the user input for selecting the indicator icon (e.g., r5) for setting the loop detector R51 related to the second indicator R5 is received, the electronic device 1000 may output a second selection UI element UI2 for selecting a region of interest to be connected to the loop detector R51 through the display 1500 in response to the user input. The second selection UI element UI2 may include the UI element for selecting the information related to the region of interest (or detected region) to be connected to the loop detector R51.

Referring to FIGS. 9 and 10, the electronic device 1000 may receive the information on the region of interest (or detected region) to be connected to the loop detector R51 from the user through the second selection UI element UI2.

For example, the user may select one region (e.g., R21) from among a plurality of second regions-of-interest R21 to R25 as a region of interest to be connected to the loop detector R511 related to the second indicator R5, through the input unit 1400.

For example, the user may select one region (e.g., R22) from among the plurality of second regions-of-interest R21 to R25 as a region of interest to be connected to the loop detector R512 related to the second indicator R5, through the input unit 1400.

Meanwhile, in FIGS. 9 and 10, it has been described that a second selection UI for connecting the specific regions-of-interest R21 and R25 and the loop detector is provided. However, this is only an example for convenience of description, and the electronic device 1000 may be implemented to connect the loop detector to an arbitrary region of interest through the second selection UI.

Meanwhile, in FIGS. 9 and 10, it has been described that the second region-of-interest to be connected to the loop detector is directly selected by the user. However, this is only an example, and the electronic device 1000 may be implemented to determine the second region-of-interest to be connected to the loop detector on the basis of the location of the loop detector in the image and the location of the second region-of-interest. For example, when the user input for setting the loop detector at a location in a specific second region-of-interest is received, the electronic device 1000 may be implemented to determine the second region-of-interest including the location of the loop detector as the region of interest to be connected to the loop detector.

According to one embodiment, the electronic device 1000 may output the selection UI for selecting the region of interest to be connected to the direction vector in response to the user input for setting the direction vector related to the first indicator R6 in operation S3000.

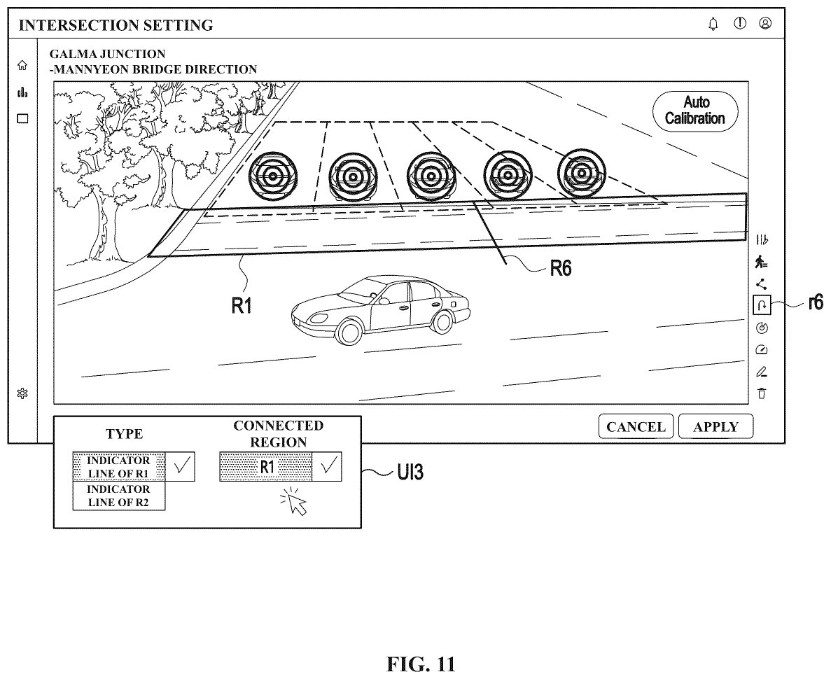

FIG. 11 is a diagram for describing an aspect of a UI for linking a region of interest to an indicator according to an embodiment of the present invention.

When the electronic device 1000 receives a user input for selecting an indicator icon (e.g., the direction vector icon r6) for setting a direction vector related to a first indicator R6, the electronic device 1000 may output a third selection UI element UI3 for selecting a region of interest to be connected to the direction vector through the display 1500 in response to the user input. The third selection UI element UI3 may include a UI element for selecting information related to the type of direction vector, and/or a region of interest to be connected to the direction vector.

Referring to FIG. 11, the electronic device 1000 may receive information related to the type of direction vector related to the first indicator R6 and/or the region of interest to be connected to the direction vector from the user through the third selection UI element UI3.

For example, the user may select, through the input unit 1400, an indicator line of R1 as the type of direction vector related to the first indicator R6. Furthermore, the user may select, through the input unit 1400, one region (e.g., R1) from among a plurality of region of interest as the region of interest to be connected to the direction vector related to the first indicator R6.

Meanwhile, in FIG. 11, it has been described that a first region-of-interest to be connected to the direction vector related to the first indicator R6 is directly selected by the user. However, this is only an example, and the electronic device 1000 may be implemented to determine a region of interest to be connected to the direction vector related to the first indicator R6 on the basis of the location where a setting input is received after the indicator icon (e.g., the direction vector icon r6) is selected. Specifically, when the electronic device 1000 receives a straight line setting input in the first region-of-interest R1 after the indicator icon (e.g., the direction vector icon r6) is selected, the electronic device 1000 may determine the type of direction vector related to the first indicator R6 as the indicator line of R1 on the basis of the location where the setting input is received, and determine the region of interest to be connected to the direction vector related to the first indicator R6 as the first region-of-interest R1 corresponding to the location where the straight line setting input is received. Meanwhile, the straight line that is input according to the straight line setting input may be set as a pedestrian measurer for counting the volume of traffic of pedestrians.

In the operation S5000 of linking the region of interest selected through the selection UI to the indicator, the electronic device 1000 may link the region of interest selected through the selection UI in operation S4000 to the indicator. In this case, the link between the selected region of interest and the indicator may be displayed through a linker.

For example, referring to FIG. 7, the electronic device 1000 may link, through the first selection UI element UI1, the first direction vector R521 and the second direction vector R522 to the second region-of-interest R21 in response to the user's selection for the second region-of-interest R21 to be connected to the first direction vector R521 and the second direction vector R522 of the second indicator R5. In this case, the server 200 may calculate road traffic indexes related to a volume of traffic of vehicles by measuring the number of vehicles exiting from the second region-of-interest R21 in a direction corresponding to the first direction vector R521 (i.e., straight ahead direction) and in a direction corresponding to the second direction vector R522 (i.e., right turn direction), on the basis of a result of the link.

For example, referring to FIG. 8, the electronic device 1000 may link, through the first selection UI element UI1, the direction vector R523 to the second region-of-interest R25 in response to the user's selection for the second region-of-interest R25 to be connected to the direction vector R523 of the second indicator R5. In this case, the server 200 may calculate road traffic indexes related to a volume of traffic of vehicles by measuring the number of vehicles exiting from the second region-of-interest R25 in a direction corresponding to the direction vector R523 (i.e., straight ahead direction) on the basis of a result of the link.

For example, referring to FIGS. 9 and 10, the electronic device 1000 may link, through the second selection UI element UI2, the loop detector R511 or R512 to the second region-of-interest R21 or R22 in response to the user's selection for the second region-of-interest R21 or R22 to be connected to the loop detector R511 or R512 of the second indicator R5 (ex. R51). In this case, the server 200 may calculate the road traffic indexes related to the volume of traffic of vehicles or the queue length of the vehicles by measuring the occupancy rate within the second region-of-interest R21 or R22 within the vehicle object on the basis of a result of the link.

For example, referring to FIG. 11, the electronic device 1000 may link, through the third selection UI element UI3, the direction vector to the first region-of-interest R1 as a pedestrian measurer in response to the user's selection for the first region-of-interest R1 to be connected to the direction vector of the first indicator R6. In this case, the server 200 may calculate road traffic indexes related to a volume of traffic of pedestrians (or two-wheeled vehicles) of the pedestrian region-of-interest by measuring the number of pedestrians (or two-wheeled vehicles) passing through the pedestrian measurer corresponding to the direction vector in the first region-of-interest R1 on the basis of a result of the link.

As described above, the electronic device 1000 may display and output one or more regions-of-interest R1 to R4 and/or one or more indicators R5 and R6 in the surveillance image. In this case, since one or more regions-of-interest R1 to R4 and/or one or more indicators R5 and R6 may overlap in the surveillance image, there may be cases where it is difficult to visually check set regions. When regions corresponding to the regions-of-interest R1 to R4 and/or regions corresponding to the indicators R5 and R6 overlap, the electronic device 1000 according to the embodiment of the present invention may assign priorities to the regions-of-interest R1 to R4 and the indicators R5 and R6 in consideration of areas of the regions occupied by the regions-of-interest R1 to R4 and the indicators R5 and R6, and display the assigned priorities in the surveillance image. For example, the electronic device 1000 may be implemented to assign priorities to the loop detector R51, the direction vectors R52 and the direction vectors related to indicator R6, the fourth region-of-interest (i.e., a region for measuring the speed of the vehicle), the first region-of-interest (i.e., a pedestrian region-of-interest), and the second region-of-interest (i.e., a vehicle region-of-interest) in descending order, and display the assigned priorities in the surveillance image. For example, the electronic device 1000 may display the region assigned the high priority with relatively high clarity (or low transparency), and display the region assigned low priority with relatively low clarity (or high transparency).

The electronic device 1000 according to the embodiment of the present invention may be implemented to receive object trajectory information in the form of a heat map from the server 200 through the communication module 1100, and display and output the received object trajectory information in the surveillance image. The object trajectory information is information in the form of a heat map showing an occupancy rate of objects (e.g., vehicle objects, pedestrian objects, two-wheeled vehicle objects) in the surveillance image for a predetermined cumulative time.

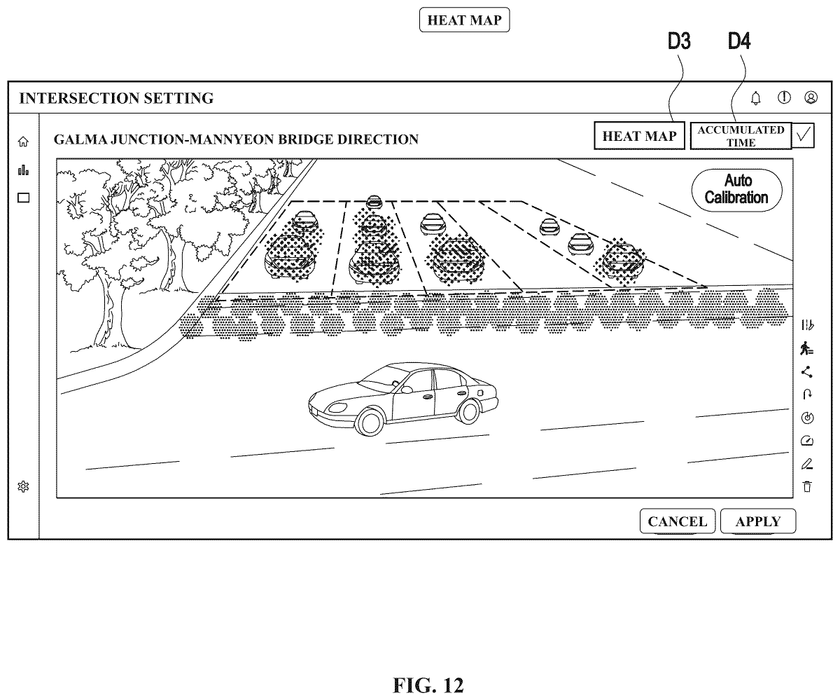

FIG. 12 is a diagram for describing an aspect of object trajectory information displayed in an image according to an embodiment of the present invention.

The electronic device 1000 may provide a selectable region (e.g., a heat map button D3 in FIG. 11) for receiving a user input requesting display of object trajectory information in the surveillance image. The user may request to activate a function for displaying the object trajectory information by selecting the heat map button D3 through the input unit 1400. Furthermore, the electronic device 1000 may provide a selectable region or an inputtable region (e.g., an accumulated time tab D4 in FIG. 11) for receiving an accumulated time, which is the basis for calculating the object trajectory information. The user may select the accumulated time or input the accumulated time using an accumulated time tab D4 through the input unit 1400.

The electronic device 1000 may be implemented to receive the object trajectory information for the accumulated time from the server 200 on the basis of the user input requesting to activate the function for displaying the object trajectory information in the surveillance image, and display and output the object trajectory information in the surveillance image.

According to the present embodiment, the user may easily set the region of interest on the basis of the object trajectory information displayed in the surveillance image. Specifically, the user may easily set the vehicle region-of-interest, which is a region through which a vehicle passes, on the basis of the object trajectory information related to the vehicle object. Furthermore, the user may easily set the pedestrian region-of-interest, which is a region through which a pedestrian (or a two-wheeled vehicle) passes, on the basis of the object trajectory information related to the pedestrian object (or the two-wheeled vehicle object).

The electronic device 1000 according to the embodiment of the present invention may be implemented to display and output a time series chart corresponding to the region of interest in the surveillance image. The time series chart may be any type of chart related to the object measured in the previously set region of interest. For example, the time series chart may include information related to road traffic indexes collected over time in response to the previously set region of interest.

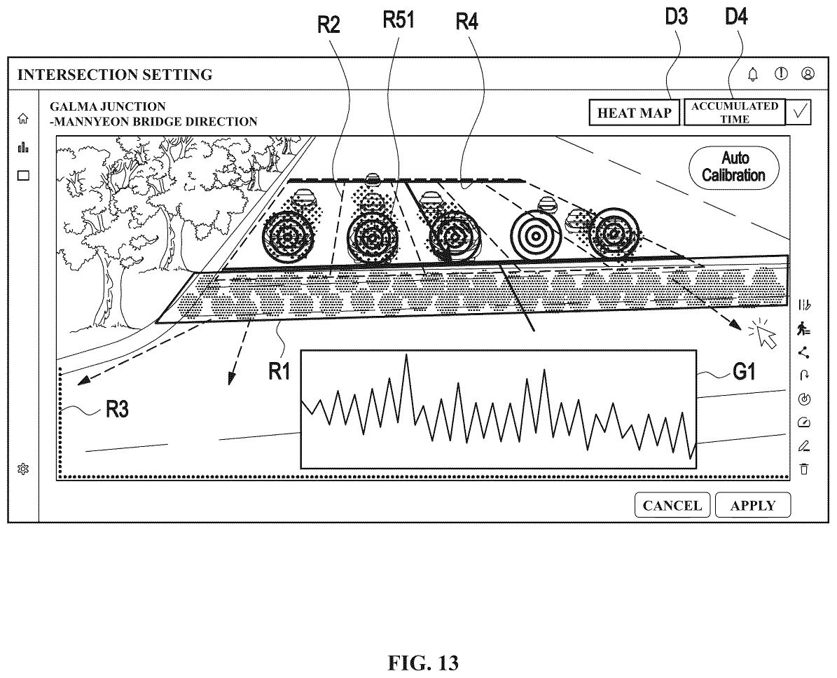

FIG. 13 is a diagram for describing an aspect of a time series chart related to a region of interest displayed in an image according to an embodiment of the present invention.

The electronic device 1000 may display and output previously set regions-of-interest R1 to R4 and indicators R5 and R6 in a surveillance image. The electronic device 1000 may receive a user input for selecting a specific region of interest (e.g., a pedestrian region-of-interest R1 in FIG. 13) from the user through the input unit 1400. In this case, the electronic device 1000 may be implemented to obtain road traffic indexes (e.g., a volume of traffic of pedestrians, a volume of traffic of two-wheeled vehicles, etc.) that have been collected in relation to the selected region of interest (e.g., the pedestrian region-of-interest R1), and display and output a time series chart G1 related to the road traffic indexes over time in the surveillance image. The time series chart G1 may include information on the previously collected road traffic indexes in a different form from the object trajectory information related to the occupancy rate of objects, and the user may determine whether the currently set region of interest is appropriately set, on the basis of the road traffic indexes of the time series chart G1. Specifically, when the road traffic indexes of the time series chart G1 are measured outside a preset range compared to the average road traffic indexes previously collected, the user may determine whether there is an error in the set region of interest on the basis of the time series chart G1, and when it is determined that there is an error in the set region of interest, the user may easily resolve the error by modifying the set region of interest.

According to a method of setting a region of interest in an image for collecting road traffic indexes, a device for performing the same, and a road traffic index collection system according to embodiments of the present invention, by providing a UI for linking a region of interest to an indicator helpful in collecting road traffic indexes, it is possible to set intersection setting information by users to easily collect the road traffic indexes.

According to a method of setting a region of interest in an image for collecting road traffic indexes, a device for performing the same, and a road traffic index collection system according to embodiments of the present invention, by linking an indicator helpful in collecting road traffic indexes to a region of interest, it is possible to obtain more accurate road traffic indexes by precisely and efficiently measuring a volume of traffic or an occupancy rate of objects in the region of interest.

According to a method of setting a region of interest in an image for collecting road traffic indexes, a device for performing the same, and a road traffic index collection system according to embodiments of the present invention, by providing a UI for linking a region of interest to an indicator helpful in collecting road traffic indexes, it is possible to set intersection setting information by users to easily collect the road traffic indexes.

According to a method of setting a region of interest in an image for collecting road traffic indexes, a device for performing the same, and a road traffic index collection system according to embodiments of the present invention, by linking an indicator helpful in collecting road traffic indexes to a region of interest, it is possible to obtain more accurate road traffic indexes by precisely and efficiently measuring a volume of traffic or an occupancy rate of objects in the region of interest.

Effects of the present invention are not limited to the above-described effects and other effects that are not described may be clearly understood by those skilled in the art from the above detailed descriptions.

Features, structures, and effects described in the above-described exemplary embodiments are included in at least one exemplary embodiment of the present invention, but are not necessarily limited to only one exemplary embodiment. Furthermore, features, structures, and effects described in each embodiment can be combined or modified and implemented in other embodiments by one of ordinary skill in the art to which the embodiments belong. Therefore, it should be interpreted that contents related to such combinations and modifications are included in the scope of the present invention.

Further, while the present invention has been particularly described with reference to embodiments, the embodiments are only exemplary embodiments of the present invention and the present invention is not intended to be limited thereto. It will be understood by those skilled in the art that modifications and applications in other forms may be made without departing from the spirit and scope of the present invention. That is, each element specifically shown in the embodiments may be modified and embodied. In addition, it should be understood that differences related to these modifications and applications are within the scope of the present invention as defined in the appended claims.

What is claimed is:

1. A method of setting a region of interest in an image for collecting road traffic indexes using an electronic device, the method comprising:
displaying surveillance images collected in real time;
setting a region of interest to obtain data related to movement of an object on the basis of an input of a user;
outputting an indicator for obtaining additional data on the basis of the input of the user;
outputting a selection user interface (UI) for selecting a region of interest related to the indicator; and
linking the region of interest selected through the selection UI to the indicator.

2. The method of claim 1, wherein the region of interest includes a vehicle region-of-interest for measuring movement of a vehicle and a pedestrian region-of-interest for measuring movement of a pedestrian.

3. The method of claim 2, wherein the indicator includes a vehicle indicator that is linkable to the vehicle region-of-interest and a pedestrian indicator that is linkable to the pedestrian region-of-interest.

4. The method of claim 3, wherein a UI is displayed together with the surveillance images,
the UI includes a region-of-interest icon for setting the region of interest, a vehicle indicator icon for setting the vehicle indicator, and a pedestrian indicator icon for setting the pedestrian indicator,
when the user selects the vehicle indicator icon, the selection UI displays a preset vehicle region-of-interest, and
when the user selects the pedestrian indicator icon, the selection UI displays a preset pedestrian region-of-interest.

5. The method of claim 4, wherein the vehicle indicator includes a loop detector for detecting an occupancy rate within the vehicle region-of-interest and a direction vector for measuring an exit direction of the vehicle, and
when the direction vector is set as a first direction and a second direction, a number of vehicles exiting from the vehicle region-of-interest in the first direction and the second direction is measured.

6. The method of claim 5, wherein the direction vector is displayed as an arrow indicating the exit direction, and
when the direction vector is linked to the vehicle region-of-interest, the link between the direction vector and the vehicle region-of-interest is displayed through a linker.

7. The method of claim 5, wherein the pedestrian indicator includes a pedestrian measurer for counting an amount of traffic for pedestrians moving in the pedestrian region-of-interest,
the UI further includes a vector icon,
when a setting input of a straight line is received in the pedestrian region-of-interest after the vector icon is selected, the straight line is set to the pedestrian measurer, and
when a setting input of a straight line is received in a region adjacent to the vehicle region-of-interest after the vector icon is selected, the straight line is set to the direction vector.

8. The method of claim 1, wherein the region of interest further includes a speed measurement region for measuring a moving speed of a vehicle in a specific region in the surveillance image, and
when the region of interest and the indicator overlap, the indicator is displayed preferentially.

9. The method of claim 4, further comprising, after the region-of-interest icon is selected, displaying an information selection window,
wherein information that is selectable through the information selection window is determined according to a type of the region of interest.

10. The method of claim 9, wherein the selectable information is determined through a pre-trained AI model, wherein the pre-trained AI model is trained, based on a dataset which the region-of-interest icon or the region-of-interest and the selectable information were matched, to determine the matched selectable information when a selection for the region-of-interest icon or the region-of-interest is received.

11. The method of claim 1, further comprising displaying a heat map on the surveillance image based on the input of the user,
wherein the heat map is generated by analyzing the surveillance images for an accumulated time.

12. The method of claim 11, wherein the UI is displayed together with the surveillance images, and
the UI includes an accumulated time input region for inputting the accumulated time.

13. The method of claim 11, further comprising, when a selection for the set region of interest is received, displaying a time series chart related to the object measured in the region of interest.

14. The method of claim 13, wherein information on the object displayed through the heat map is different from information on the object displayed through the time series chart.

15. A non-transitory computer-readable recording medium on which a computer program executed by a computer is recorded, the computer program comprising:
displaying surveillance images collected in real time;
setting a region of interest to obtain data related to movement of an object on the basis of an input of a user;
outputting an indicator for obtaining additional data on the basis of the input of the user;
outputting a selection user interface (UI) for selecting a region of interest related to the indicator; and
linking the region of interest selected through the selection UI to the indicator.

16. An electronic device comprising:
a communication module configured to receive image data captured by a camera; and
a processor configured to set a region of interest for collecting road traffic indexes in the image data on the basis of the image data,
wherein the processor is configured to display surveillance images collected in real time, set a region of interest to obtain data related to movement of an object on the basis of an input of a user, output an indicator for obtaining additional data on the basis of the input of the user, output a selection user interface (UI) for selecting a region of interest related to the indicator, and link the region of interest selected through the selection UI to the indicator.
